(19) United States
(12) Patent Application Publication
(10) Pub. No.: US 2025/0157456 A1
(43) Pub. Date: May 15, 2025

(54) SEMI-SUPERVISED TEXT-TO-SPEECH BY GENERATING SEMANTIC AND ACOUSTIC REPRESENTATIONS

(71) Applicant: Google LLC, Mountain Way, CA (US)

(72) Inventors: Evgeny Kharitonov, Paris (FR); Damien Vincent, Zürich (CH); Zalán Borsos, Zurich (CH); Raphaël Marinier, Paris (FR); Olivier Claude Pietquin, Lille (FR); Matthew Sharifi, Kilchberg (CH); Marco Tagliasacchi, Ruvigliana (CH); Neil Zeghidour, Paris (FR)

(21) Appl. No.: 18/832,325

(22) PCT Filed: Jan. 26, 2024
(86) PCT No.: PCT/US2024/013149

§ 371 Date: Jul. 23, 2024

Related U.S. Application Data
(60) Provisional application No. 63/441,418, filed on Jan. 26, 2023.

(51) Int. Cl. G10L 13/027; G06F 40/284; G06F 40/30; G10L 13/08

(52) U.S. Cl. CPC G10L 13/027; G06F 40/284; G06F 40/30; G10L 13/08

(57) ABSTRACT

Methods, systems, and apparatus, including computer programs encoded on a computer storage medium, for generating an audio signal from input text. In one aspect, a method comprises receiving a request to convert input text into an audio signal, wherein the input text comprises multiple tokenized text inputs, generating, using a first generative neural network, a semantic representation of the tokenized text inputs comprising semantic tokens representing semantic content of the tokenized text inputs, each semantic token being selected from a vocabulary of semantic tokens, generating, using a second generative neural network and conditioned on at least the semantic representation, an acoustic representation of the semantic representation comprising one or more respective acoustic tokens representing acoustic properties of the audio signal, and processing the acoustic representation using a decoder neural network to generate the audio signal.

### CROSS-REFERENCE TO RELATED APPLICATIONS

This application claims priority to U.S. Provisional Application No. 63/441,418, filed on Jan. 26, 2023. The disclosure of the prior application is considered part of and is incorporated by reference in the disclosure of this application.

### BACKGROUND

This specification relates to generating audio from text using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates an audio signal from text using one or more generative neural networks.

According to a first aspect there is provided a computer-implemented method for generating an audio signal from input text. The method comprises receiving a request to convert input text into an audio signal, wherein the input text comprises a plurality of tokenized text inputs.

As used in this specification, tokenized text inputs are a sequence of tokens that each represent text of the input text. Each token is selected from a vocabulary of tokens, where each token represents a one or more characters, word pieces, and other text symbols.

The system generates, using a first generative neural network, a semantic representation of the tokenized text inputs comprising semantic tokens representing semantic content of the tokenized text inputs. Each semantic token is selected from a vocabulary of semantic tokens and represents semantic content of the input text. Examples of semantic content represented by the semantic tokens can include linguistic content for speech.

The system generates, using a second generative neural network and conditioned on at least the semantic representation, an acoustic representation of the semantic representation comprising one or more respective acoustic tokens representing acoustic properties of the audio signal. When the generation is conditioned on a context that specifies acoustic properties of the audio signal to be generated, the system can condition the generation on the context. Examples of this can include when the context specifies a target voice prompt for the output audio signal.

The system then processes the acoustic representation using a decoder neural network to generate the audio signal.

Particular embodiments of the subject matter described in this specification can be implemented so as to realize one or more of the following advantages.

Conventional systems that use neural networks to generate speech from text require a large amount of labeled data to train the neural network. In particular, these systems require a large amount of parallel data (e.g., data including input text and speech outputs, i.e. corresponding text and speech pairs) in order to effectively train the neural network.

In some examples, however, a large amount of parallel data is not available. For example, parallel data may not be as abundant for certain low-resource languages. In this case, a conventionally trained system generates speech that may not be diverse and has limited speech generation capacity as a result of lack of diversity in the parallel data. For example, the parallel data used to train the neural network may not include speakers with various accents, speakers of diverse demographics, or may be recorded in heterogenous recording conditions, as a result of the limited amount of data for the low-resource language. Such data could only comprise a single speaker or a limited number of speakers.

In contrast, the system described leverages audio-only data (i.e. unlabeled audio data) to reduce the need for supervision in training the generative neural networks, which can increase efficiency and can increase the amount of diversity in the training data. In particular, the system generates a semantic representation from input text and an acoustic representation from the semantic representation, which reduces the training into two sequence-to-sequence tasks. By dividing the training into two tasks, the system can use a generative neural network for each task, which allows for increasing efficiency in inference and decreasing latency in training. For example, the system can generate the acoustic representation from the semantic representation by training the generative neural network on a large amount of unlabeled speech data, allowing for increased efficiency in training and for greater diversity in generating speech for low-resource languages.

Additionally, the system can perform pre-training and backtranslation on the generative neural network that generates the semantic representation from the input text. By performing pre-training and backtranslation, the system fine-tunes the generative neural network, which reduces the amount of parallel data supervision required for training. For example, the system can produce a large dataset by combining pretraining and backtranslation to draw data from a small parallel dataset, which increases the overall efficiency of the process of training the generative neural network and improves the performance of the generative neural network. That is, the generative neural network may be pre-trained on unlabeled audio data. The generative neural network may also be trained on a backtranslation task, that is, converting from a semantic representation back to its corresponding text, using the small parallel dataset. The backtranslation model may be used to synthesize text corresponding to the unlabeled audio data to generate a large quantity of additional synthetic parallel data. This additional parallel data and the small parallel dataset may be used to fine-tune the generation system. In this way, only a small amount of parallel data may be required for training. In conventional text to speech systems, hundreds of hours of parallel data may be required to train the system. Using the techniques disclosed herein, the more abundant and more easily obtainable unlabeled audio data may be used instead, together with a small amount of true parallel data. In some cases, the amount of true parallel data can be as little as 15 minutes from a single speaker whilst still maintaining comparable performance.

Additionally, the system can perform voice prompting on the generative neural network that generates the acoustic representation from the semantic representation. By performing prompting, the system can use multiple speakers as target speakers in generating the acoustic representation using the generative neural network. The system conditions the neural network with a small portion of semantic representation and acoustic representation of a target voice prompt from the target speaker. Using the target voice prompts allows for the generative neural network to generate acoustic representations that include features (e.g., voice, tempo, and recording conditions) of the target speaker, which can be leveraged for multiple speakers. By performing voice prompting, the system can generate audio in the form of a variety of speakers using a small portion of data, which can increase the diversity of the generated speech. That is, the system can generalize to unseen speakers and the system does not require any speaker labelling of the training data.

Overall, by dividing the generation tasks to a first task of generating the semantic representation from the tokenized text inputs and a second task of generating the acoustic representations from the semantic representation, the system described reduces latency associated with data collection by using pre-training and backtranslation to leverage a small parallel dataset, and the system generates diverse speech from multiple speakers with increased efficiency. An improved text to speech system with increased capabilities is thereby provided.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a block diagram of an example training system.

FIGS. 3A-3C are example diagrams of an acoustic generative neural network.

FIG. 4 is a flow diagram of an example process for generating an audio signal from text using one or more generative neural networks.

Like reference numbers and designations in the various drawings indicate like elements.

### DETAILED DESCRIPTION

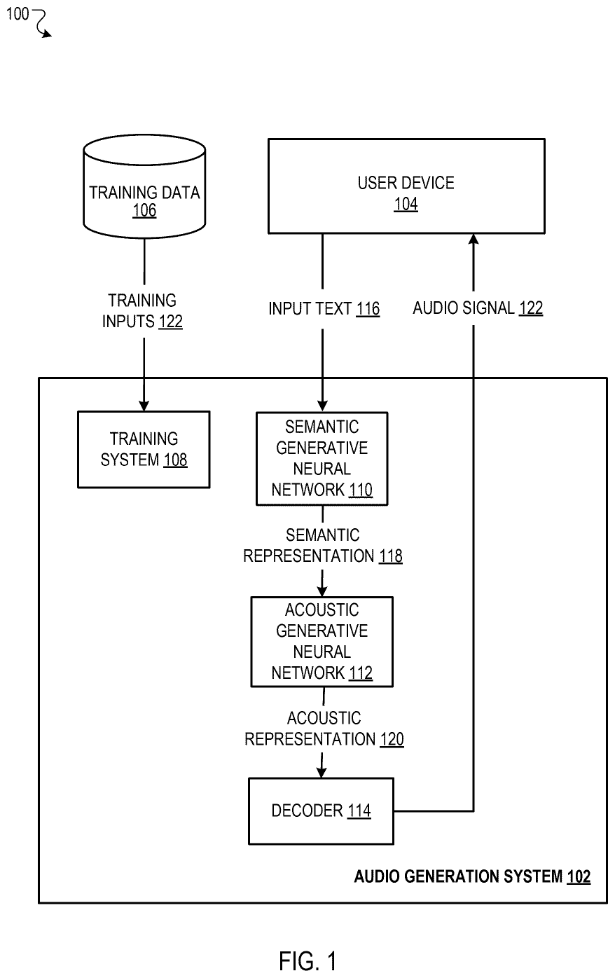

FIG. 1 shows an example system 100. The system 100 is an example of a system implemented as computer programs on one or more computers in one or more locations in which the systems, components, and techniques described below are implemented.

The system 100 is configured to generate an audio signal from text using one or more generative neural networks. An audio signal may be an audio waveform or any suitable audio encoding.

The system 100 includes an audio generation system 102, a user device 104, and training data 106. The user device 104 can be a computer, and the user device 104 can provide input text 116 to the audio generation system 102.

The input text 116 includes text tokens (e.g., tokenized inputs) selected from a vocabulary of text tokens that represent or more characters, word pieces, or other text symbols.

The audio generation system 102 includes a training system 108, a semantic generative neural network 110 (first generative neural network), an acoustic generative neural network 112 (second generative neural network), and a decoder 114.

The audio generation system 102 is configured to process the input text 116 using the semantic generative neural network 110 and the acoustic generative neural network 112 to generate an audio signal 122.

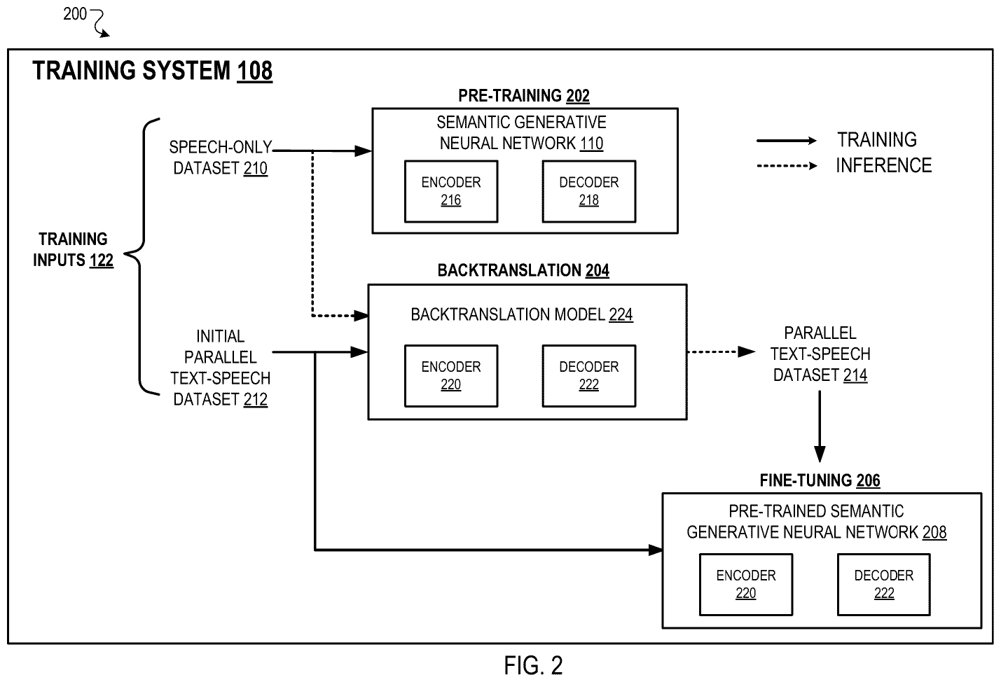

In particular, the system generates a semantic representation 118 of the input text 116 by using the semantic generative neural network 110 to process the input text 116, and the system provides the semantic representation 118 to the acoustic generative neural network 112. The semantic representation 118 includes one or more semantic tokens each representing semantic content of the tokenized text inputs. In particular, the system selects each semantic token from a vocabulary of semantic tokens, as described in further detail below with reference to FIG. 2.

In some examples, the semantic tokens represent linguistic content, such as phonetics and semantics, and do not represent paralinguistic information, such as speaker identity and acoustic information.

By using the semantic representation 118 as an intermediate representation between the input text 116 and the acoustic representation 120, the system can encode the semantic representation 118 with largely phonetic content and limited speaker information, which can increase the efficiency of mapping text tokens to an acoustic representation.

The system generates an acoustic representation 120 of the semantic representation 118 by using the acoustic generative neural network 112 to process the semantic representation 118.

The acoustic representation 120 includes one or more respective acoustic tokens for each semantic token each representing acoustic properties of the audio signal 122. Any appropriate set of acoustic tokens may be used. For example, as described below, the vocabulary of acoustic tokens may be provided using the codebook of an audio codec.

The system generates the audio signal 122 by using the decoder 114 to process the acoustic representation 120. In particular, the audio signal 122 represents one or more audio characteristics such as voice, tempo, and/or recording conditions.

The semantic generative neural network 110 can have an encoder-decoder Transformer architecture, and the acoustic generative neural network 112 can have a decoder-only Transformer architecture.

Generally, the Transformer architecture includes a sequence of attention blocks, and, during the processing of a given input, each attention block receives a respective input hidden state for each input token in the given input. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block. The output subnetwork then processes the output hidden state generated by the last attention block in the sequence for the last input token in the input sequence to generate an output.

In some examples, the decoder 114 is a decoder neural network part of a neural audio codec (e.g., the SoundStream codec, details of which may be found in N. Zeghidour et al., “SoundStream: An End-to-End Neural Audio Codec,” in IEEE/ACM Transactions on Audio, Speech, and Language Processing, vol. 30, pp. 495-507, 2022, which is hereby incorporated by reference in its entirety, or another audio codec) configured to reconstruct audio data by processing an acoustic representation of the audio data.

In particular, the neural codec neural network includes an encoder neural network, a quantizer, and the decoder 114. The encoder neural network can be a neural network configured to convert a fixed input, such as the audio signal 122, into encoded audio data, such as a vector of fixed dimensionality that represents the audio signal 122.

The quantizer can be a residual quantizer configured to quantize the encoded data (e.g. the encoded audio data) using a number of quantization levels (e.g., three quantization levels). In this case, the decoder 114 is configured to use a codebook to map the quantized encoded data to an acoustic representation 120 of one or more acoustic tokens that represent the quantized encoded data, where the codebook includes multiple acoustic tokens. That is, the vocabulary of the acoustic tokens may be based upon the codebook. The decoder can then reconstruct the audio signal 122 by processing the each of the one or more acoustic tokens of the acoustic representation 120.

During training, the audio generation system 102 can use the training system 108 to train the semantic generative neural network 110. In particular, the audio generation system 102 uses the training system 108 to train the semantic generative neural network on training inputs 122 from the training data 106. The audio generation system 102 can use a trained speech representation model (e.g., w2v-BERT, details of which may be found in Y.-A. Chung et al., “w2v-BERT: Combining Contrastive Learning and Masked Language Modeling for Self-Supervised Speech Pre-Training,” 2021 IEEE Automatic Speech Recognition and Understanding Workshop (ASRU), Cartagena, Colombia, 2021, pp. 244-250 which is hereby incorporated by reference in its entirety) to generate semantic representations for training, where the one or more semantic tokens represent audio signals from one or more datasets. In particular, the audio generation system 102 generates the semantic representations by using the trained speech representation model to process multiple audio signals from the one or more datasets, and the audio generation system 102 can use the semantic representations for training the semantic generative neural network 110, the acoustic generative neural network 112, or both. For example, the trained speech representation model may provide an embedding of input text. The embedding space may be discretized to provide a vocabulary of semantic tokens. In one example, the embedding space is quantized using k-means clustering.

In particular, the training inputs 122 include a speech-only dataset and an initial parallel text-speech dataset. The speech-only dataset can be a relatively large dataset of training examples that include multiple semantic representations each corresponding to an audio signal. The training system 108 extracts (e.g., generates) the semantic representations of the training examples of the speech-only dataset by processing audio signals of a larger speech-only dataset using the trained speech representation model. In particular, the larger speech-only dataset includes multiple hours of audio recordings from multiple speakers. Each of the audio recordings are unlabeled (e.g., do not include corresponding transcriptions).

The initial parallel text-speech dataset is a relatively small dataset of training examples that includes multiple semantic representations each corresponding to input text, e.g., a transcription of the corresponding audio data. The training system 108 extracts semantic representations of the training examples by processing audio signals of a parallel dataset using the trained speech representation model. The corresponding transcriptions can be, e.g., manually transcribed from each of the audio recordings.

Training the semantic generative neural network 110 is described in more detail below with reference to FIG. 2.

In some examples, the audio generation system 102 can use the training system 108 to train the acoustic generative neural network 112. In particular, the audio generation system 102 uses the training system 108 to train the acoustic generative neural network 112 by providing the training inputs 122 to the acoustic generative neural network 112, as described in further detail below with reference to FIG. 2. In this case, the training inputs 122 further include an audio-only dataset for training the acoustic generative neural network 112. The audio-only dataset can be a dataset of training examples including audio inputs each corresponding to a respective semantic representation and a respective acoustic representation pair. The training system 108 extracts the semantic representation of the training examples of the audio-only dataset from the larger speech-only dataset using the trained speech representation model. Additionally, the training system 108 can generate the corresponding acoustic representation of semantic representation and acoustic representation pairs by processing the audio signals of the audio-only dataset using the neural audio codec, where the acoustic tokens of the acoustic representation are the outputs of the quantizer.

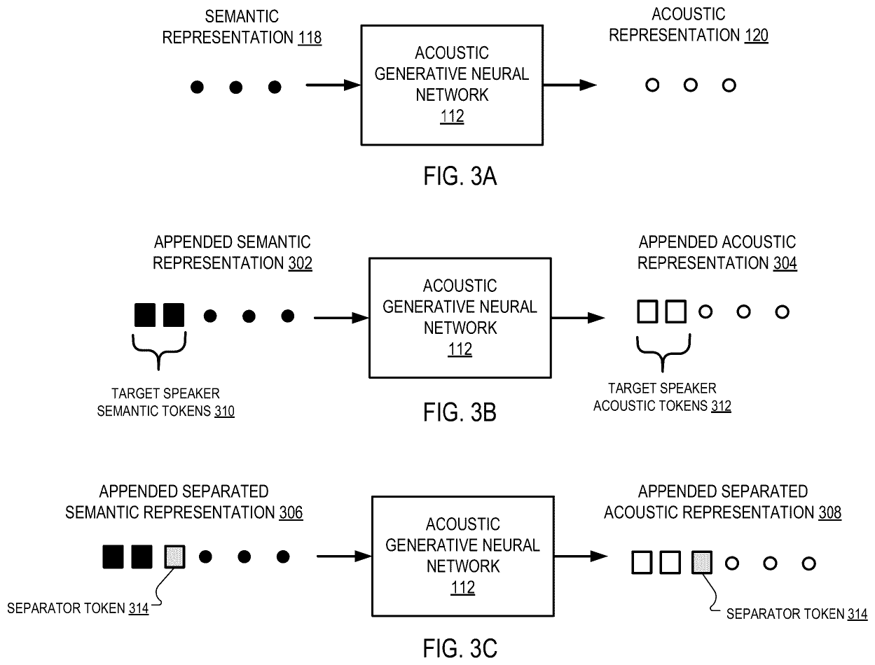

In some examples, the audio generation system 102 can use voice-prompting to condition the acoustic generative neural network on a semantic representation of a target voice prompt, as described in further detail with reference to FIG. 3. The semantic representation of the target voice prompt can include semantic tokens representing the target voice prompt, and, in some examples, an acoustic representation of the target voice prompt including acoustic tokens.

Overall, by generating a semantic representation from the input text and an acoustic representation from the semantic representation of the input text, the system can divide the inference and the training into two sequence-to-sequence tasks. Division of the sequence-to-sequence tasks can result in increased quality of training of the generative neural network for each task. Additionally, the system can reduce latency associated with data collection for training by using pre-training and backtranslation to leverage the relatively small text-speech dataset, which, along with performing voice-prompting, allows the system to generate diverse speech from multiple speakers with increased efficiency.

FIG. 2 shows a block diagram of an example training system. The training system 108 is an example of a system in which the systems, components, and techniques described below are implemented. For example, a system, e.g., the audio generation system 102 of FIG. 1, appropriately configured in accordance with this specification, can implement the training system 108.

The training system 108 can train the semantic generative neural network 110 to process the input text 116 and generate a semantic representation 118 of the input text 116, and the acoustic generative neural network to process the semantic representation 118 to generate the acoustic representation 120.

The semantic generative neural network 110 includes an encoder 216 trained to encode training inputs 122 that include text tokens and a decoder 218 trained to decode (e.g., uncorrupt) the training inputs 122 by mapping the text tokens to one or more semantic tokens of a semantic representation. In general, an encoder and a decoder of a neural network can have a number of layers (e.g., blocks) for performing a task.

The training inputs 122 include the speech-only dataset 210 and the initial parallel text-speech dataset 212. The speech-only dataset 210 includes multiple semantic representations each corresponding to an audio signal, and the initial parallel text-speech dataset 212 includes multiple semantic representations each corresponding to input text, where the semantic representations are extracted from audio signals that correspond to the input text.

In general, the training system 108 performs pre-training 202 to pre-train the semantic generative neural network 110 on a denoising objective using the speech-only dataset, and the training system 108 performs backtranslation 204 by training a backtranslation model to generate text tokens from audio inputs, where the training system 108 uses the trained backtranslation model 224 to generate a parallel-text speech dataset 214. The training system then performs fine-tuning 206 by fine-tuning the pre-trained semantic generative neural network 208 using the generated parallel-text speech dataset 214 and the initial text-speech dataset 212.

The training system 108 performs pre-training 202 of the semantic generative neural network 110 by training the semantic generative neural network 110 to generate uncorrupted semantic representations. In particular, the training system 108 pre-trains the encoder 216 and the decoder 218 of the semantic generative neural network 110 on the denoising objective using the speech-only dataset 210. In particular, prior to pre-training 202, the training system 108 processes the semantic representations of the speech-only dataset 210 to generate corrupted versions of the semantic representations. For example, the training system 108 can process a sequence of multiple semantic tokens and generate a corrupted version of the sequence by randomly substituting, deleting, or masking one or more semantic tokens of the sequence. The training system 108 can then provide the corrupted sequence of semantic tokens and the uncorrupted sequence of semantic tokens to the semantic generative neural network 110 to train the semantic generative neural network 110 on the denoising objective.

The denoising objective includes generating uncorrupted semantic representations (e.g., sequences of semantic tokens) by processing the corrupted semantic representations generated from speech-only dataset 210. In this case, the semantic generative neural network 110 is pre-trained to perform denoising by predicting masked semantic tokens based on the context of surrounding uncorrupted semantic tokens. For example, the semantic generative neural network 110 is trained to encode the corrupted semantic representations and generate uncorrupted semantic representations based on a contrastive loss using the ground-truth training inputs (e.g., the corresponding uncorrupted semantic representations).

After pre-training the semantic generative neural network 208, the system performs backtranslation 204 to generate the parallel text-speech dataset 214 for fine-tuning the pre-trained semantic generative neural network 208. The parallel text-speech dataset 214 includes text tokens that each correspond to a semantic representation 118.

The training system 108 generates the text tokens of the parallel-text speech dataset by processing the semantic representations of the speech-only dataset 210 using a backtranslation model 224. The backtranslation model 224 is trained to generate tokenized text corresponding to a semantic representation by processing the semantic representation. In particular, the backtranslation model 224 includes an encoder 220 trained to encode semantic representations from the initial parallel-text speech dataset 212 and a decoder 222 configured to generate tokenized text corresponding to the semantic representations of the initial parallel-text speech dataset 212. The backtranslation model 224 may be initialized from the pre-trained semantic generative neural network 208.

During training of the back-translation model 224, the system trains (e.g., generates) the backtranslation model by fine-tuning each of the layers of the decoder 222 on an objective using the initial parallel text-speech dataset 212. The objective includes generating tokenized text by processing the semantic representations of the initial parallel text-speech dataset 212. In this case, the system fixes the encoder 220 (i.e. the parameters of the encoder 220 are held fixed and are not modified).

During inference of the backtranslation model 224, the system uses the backtranslation model 224 to generate the parallel-text speech dataset 214 by processing the semantic representations of the speech-only dataset 212 and generating corresponding tokenized text. Thus, the parallel text-speech dataset includes the audio input and tokenized text pairs, and the system can generate a relatively large dataset using the backtranslation model 224, which can increase the efficiency of fine-tuning the semantic generative neural network 208 and can generate larger amounts of training data for low-resource languages.

The system then performs fine-tuning 206 on the pre-trained semantic generative neural network 208 using the initial parallel text-speech dataset 212 and the generated parallel text-speech dataset 214. The system first fine-tunes the pre-trained semantic generative neural network 208 on an objective to generate semantic representations of tokenized text of the parallel text-speech dataset 214. In particular, the system fine-tunes the pre-trained semantic generative neural network 208 by fine-tuning the lower layers) of the encoder 220 and fixing the upper layers of the encoder 220 and the decoder 222 (that is, the corresponding parameters are held fixed and not modified). The number of layers to fine-tune is based on a hyperparameter associated with the amount of training inputs 122.

After fine-tuning the pretrained semantic generative neural network 208 using the parallel text-speech dataset 214, the system fine-tunes the pre-trained semantic generative neural network 208 on the initial parallel text-speech dataset by fine-tuning the decoder 222 and fixing the encoder 220 of the pre-trained semantic generative neural network (that is, the parameters of the encoder 220 are held fixed and not modified).

Thus, by performing pre-training and backtranslation in order to generate the large parallel-text speech dataset 214, the training system 108 can efficiently train the semantic generative neural network 208. In particular, the system can train the semantic generative neural network 208 on a large amount of unlabeled speech data, which can increase the quality and the diversity of the generated speech regardless of the size of the initial parallel data (e.g., the initial parallel text-speech dataset 212) or whether the initial parallel data includes speech for only a single speaker.

FIG. 3A is an example diagram of an acoustic generative neural network that is configured to generate an acoustic representation of a semantic representation. For convenience, the acoustic generative neural network 112 will be described as being implemented by a system. For example, an audio generation system, e.g., the audio generation system 102 of FIG. 1, appropriately configured in accordance with this specification, can implement the acoustic generative neural network 112.

The system can train the acoustic generative neural network 112 to generate the acoustic representation 120 by processing the semantic representation 118. The acoustic representation 120 includes one or more acoustic tokens corresponding to respective semantic tokens of the semantic representation 118, where each of the acoustic tokens represent acoustic properties of the audio signal.

In general, by separating the task of generating the semantic representation and the task of generating the acoustic representation, the system can efficiently train the acoustic generative neural network 112 using an audio-only dataset.

In particular, the system trains the acoustic generative neural network 112 on an objective to map semantic tokens of the semantic representation to one or more acoustic tokens for each semantic representation and acoustic representation pair of the audio-only dataset. The acoustic tokens represent features of the speech or sound, such as particular voice, tempo, and/or recording conditions. Additionally, because the system trains the acoustic generative neural network separately from the semantic generative neural network, the acoustic generative neural network can be trained to generate acoustic tokens with features of multiple speakers, regardless of whether semantic generative neural network is trained on a single-speaker dataset. In some examples, the system can use voice-prompting to generate a prompt-aware acoustic representation during inference of the acoustic generative neural network 112, as described in further detail below with reference to FIGS. 3B and 3C.

FIG. 3B is an example diagram of performing voice-prompting during inference of an acoustic generative neural network to generate an appended acoustic representation of a semantic representation. For convenience, the acoustic generative neural network 112 will be described as being implemented by a system. For example, an audio generation system, e.g., the audio generation system 102 of FIG. 1, appropriately configured in accordance with this specification, can implement the acoustic generative neural network 112.

In some examples, the system can perform voice-prompting by conditioning the acoustic generative neural network 112 with a portion of a semantic representation and an acoustic representation of a target voice prompt from a target speaker. In particular, the system can generate an appended semantic representation 302, and the system can process the appended semantic representation 302 using the trained acoustic generative neural network 112 to generate an appended acoustic representation 304.

For example, the system can obtain a semantic representation of a target voice prompt that includes the target speaker semantic tokens 310 and an acoustic representation of the target voice prompt that includes the target speaker acoustic tokens 312. The system can prepend the semantic tokens 310 of the target voice prompt to the semantic representation 118 to generate the appended semantic representation 302. The system can then process the appended semantic representation 302 to generate the acoustic representation 120, and the system appends the acoustic tokens 312 of the target voice prompt to the acoustic representation 120 to generate the appended acoustic representation.

Thus, the system can efficiently generate the acoustic representation 120 and preserve the voice and speaking conditions of the target speaker represented by the acoustic tokens 312, which is particularly useful for low-resource languages where only single-speaker parallel data is available. Additionally, voice-prompting allows for minimizing the noise of the generated acoustic representation 120 based on selecting a relatively noise-free voice prompt for conditioning.

FIG. 3C is an example diagram of performing voice-prompting during inference of an acoustic generative neural network to generate an appended separated acoustic representation of a semantic representation. For convenience, the acoustic generative neural network 112 will be described as being implemented by a system. For example, an audio generation system, e.g., the audio generation system 102 of FIG. 1, appropriately configured in accordance with this specification, can implement the acoustic generative neural network 112.

The system can perform voice-prompting by conditioning the acoustic generative neural network 112 with a portion of a semantic representation and an acoustic representation of a target voice prompt from a target speaker. In some examples, the system can generate an appended semantic representation 302, and the system can process the appended semantic representation 302 using the trained acoustic generative neural network 112 to generate an appended acoustic representation 304.

In some other examples, the system can insert separator tokens 314 to generate an appended separated semantic representation 305 and an appended acoustic semantic representation 308. In particular, the system can insert a first separator token 314 between the target speaker semantic tokens 310 and the semantic representation 118 and a second separator token 314 between the target speaker acoustic tokens 312 and the acoustic representation 120.

By inserting the separator tokens, the system can efficiently condition the acoustic generative neural network to generate acoustic representation 120 based on the target voice prompt by indicating a discontinuity between the target speaker tokens and the semantic tokens, which reduces the level of noise in generating the acoustic representation 120.

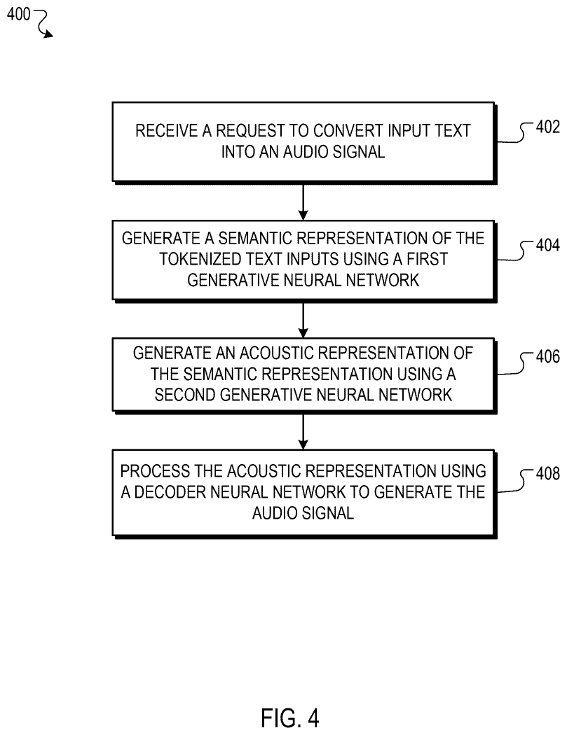

FIG. 4 is a flow diagram of an example process for generating an audio signal from text using one or more generative neural networks. For convenience, the process 400 will be described as being performed by a system. For example, a system, e.g., the audio generation system 102 of FIG. 1, appropriately configured in accordance with this specification, can perform the process 400.

The system can receive a request to convert input text into an audio signal (402). The input text includes multiple tokenized text inputs (e.g., text tokens).

The system can generate a semantic representation of the tokenized text inputs using a first generative neural network (404). In particular, the system processes the text tokens using the first generative neural network (e.g., the semantic generative neural network) to generate the semantic representation. The semantic representation includes semantic tokens representing semantic content of the text tokens, where each semantic token is selected from a vocabulary of semantic tokens.

The semantic generative neural network may have an encoder-decoder Transformer architecture, and the semantic generative neural network may be trained on a parallel text-speech dataset that maps text to semantic representations of audio corresponding to the text.

In general, the system can train the semantic generative neural network by performing pre-training on a first objective, performing backtranslation using a backtranslation neural network to generate the parallel-text speech dataset, and fine-tuning the semantic generative neural network on a second objective.

The system can pre-train the semantic generative neural network on the first objective using semantic representations of a speech-only dataset, and the system fine-tunes the pre-trained semantic generative neural network on the second objective using the parallel text-speech dataset. The first objective may include generating uncorrupted semantic representations of the speech-only dataset by denoising corrupted semantic representations of the speech-only dataset, and the second objective may include generating semantic representations of text of the parallel text-speech dataset.

After pre-training semantic generative neural network, the system can generate the parallel-text speech dataset by generating a backtranslation model that backtranslates from semantic representations to text and generating the parallel-text speech dataset by processing the speech-only dataset using the back translation model. In particular, the system generates the backtranslation model by fine-tuning the pre-trained semantic generative neural network on a third objective using an initial parallel text-speech dataset. The third objective may include generating semantic representations of text of the initial parallel-text speech dataset.

The system can then fine-tune the pre-trained semantic generative neural network by fine-tuning lower layers of the encoder of the pre-trained semantic generative neural network and fixing the upper layers of the encoder and the decoder of the pre-trained semantic generative neural network. After fine-tuning the pretrained semantic generative neural network on the second objective using the parallel text-speech dataset, the system can fine-tune the pre-trained semantic generative neural network on the initial parallel-text speech dataset by fine-tuning the decoder and fixing the encoder of the pre-trained semantic generative neural network.

The system can generate an acoustic representation of the semantic representation using a second generative neural network (406). In particular, the system processes the semantic tokens using the second generative neural network (e.g., the acoustic generative neural network) to generate the acoustic representation of the semantic representation. The acoustic representation includes one or more respective acoustic tokens for each of the semantic tokens. The acoustic tokens may represent acoustic properties of the audio signal.

The acoustic generative neural network can have a decoder-only Transformer architecture, and the acoustic generative neural network may be trained on an audio-only dataset. The audio-only dataset may include a respective semantic representation and a respective acoustic representation for each of multiple training audio inputs.

In some examples, the system obtains a semantic representation of a target voice prompt that includes semantic tokens and an acoustic representation of the target voice prompt that includes acoustic tokens. In this case, the second generative neural network may be conditioned on at least the semantic representation and the acoustic representation of the target voice prompt. For example, the system prepends the semantic representation of the target voice prompt prior to the semantic representation of the tokenized inputs, and the system then generates an appended semantic representation by appending the acoustic representation of the target voice prompt after the semantic representation of the tokenized text inputs. In this example, the acoustic generative neural network is conditioned on the appended semantic representation.

In some examples, the system can generate the appended semantic representation by inserting a first separator token between the semantic representation of the target voice prompt and the semantic representation of the tokenized inputs and inserting a second separator token between the semantic representation of the tokenized inputs and the acoustic representation of the target voice prompt.

The system can process the acoustic representation using a decoder neural network to generate the audio signal (408). In particular, the audio signal represents audio characteristics, such as voice, tempo, and recording conditions.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for generating an audio signal from input text, the method comprising:
receiving a request to convert input text into an audio signal, wherein the input text comprises a plurality of tokenized text inputs;
generating, using a first generative neural network, a semantic representation of the tokenized text inputs comprising semantic tokens representing semantic content of the tokenized text inputs, each semantic token being selected from a vocabulary of semantic tokens;
generating, using a second generative neural network and conditioned on at least the semantic representation, an acoustic representation of the semantic representation comprising one or more respective acoustic tokens representing acoustic properties of the audio signal; and
processing the acoustic representation using a decoder neural network to generate the audio signal.

2. The method of claim 1, wherein the first generative neural network has an encoder-decoder Transformer architecture.

3. The method of claim 2, wherein the first generative neural network is trained on a parallel text-speech dataset that maps text to semantic representations of audio corresponding to the text.

4. The method of claim 3, wherein the training on the parallel text-speech dataset comprises:
pre-training the first generative neural network on a first objective using semantic representations of a speech-only dataset; and
fine-tuning the pre-trained first generative neural network on a second objective using the parallel text-speech dataset.

5. The method of claim 4, wherein fine-tuning the pre-trained first generative neural network on a second objective using the parallel text-speech dataset further comprises:
fine-tuning lower layers of the encoder of the pre-trained first generative neural network and fixing the upper layers of the encoder of the pre-trained first generative neural network and the decoder of the pre-trained first generative neural network.

6. The method of claim 5, wherein the training comprises, after pre-training the first generative neural network:
generating a backtranslation model that backtranslates from semantic representations to text by fine-tuning the pre-trained first generative neural network on a third objective using an initial parallel text-speech dataset; and
generating the parallel-text speech dataset by processing the speech-only dataset using the backtranslation model.

7. The method of claim 6, wherein the training further comprises, after fine-tuning the pre-trained first generative neural network on a second objective using the parallel text-speech dataset:
fine-tuning the pre-trained first generative neural network on the initial parallel-text speech dataset.

8. The method of claim 7, wherein fine-tuning the pre-trained first generative neural network on the initial parallel-text speech dataset further comprises:
fine-tuning the decoder of the pre-trained first generative neural network and fixing the encoder of the pre-trained first generative neural network.

9. The method of claim 4, wherein the first objective comprises generating uncorrupted semantic representations of the speech-only dataset by denoising corrupted semantic representations of the speech-only dataset.

10. The method of claim 4, wherein the second objective comprises generating semantic representations of text of the parallel text-speech dataset.

11. The method of claim 6, wherein the third objective comprises generating semantic representations of text of the initial parallel-text speech dataset.

12. The method of claim 1, wherein the second generative neural network has a decoder-only Transformer architecture.

13. The method of claim 1, wherein the second generative neural network is trained on an audio-only dataset, wherein the audio-only dataset comprises, for each of a plurality of training audio inputs, a respective semantic representation and a respective acoustic representation.

14. The method of claim 1, further comprising:
obtaining a semantic representation of a target voice prompt comprising semantic tokens and a acoustic representation of the target voice prompt comprising acoustic tokens; and
wherein the second generative neural network is conditioned on at least the semantic representation of the target voice prompt and the acoustic representation of the target voice prompt.

15. The method of claim 14, wherein generating, using a second generative neural network and conditioned on at least the semantic representation, an acoustic representation of the semantic representation further comprises:
prepending the semantic representation of the target voice prompt prior to the semantic representation of the tokenized inputs; and
generating an appended semantic representation by appending the acoustic representation of the target voice prompt after the semantic representation of the tokenized text inputs, wherein the second generative neural network is conditioned on the appended semantic representation.

16. The method of claim 15, wherein generating the appended semantic representation further comprises:
inserting a first separator token between the semantic representation of the target voice prompt and the semantic representation of the tokenized inputs; and
inserting a second separator token between the semantic representation of the tokenized inputs and the acoustic representation of the target voice prompt.

17. The method of claim 1, wherein the decoder neural network generates the audio signal comprising audio characteristics of voice, tempo, and recording conditions.

18. A system comprising:
one or more computers; and
one or more storage devices communicatively coupled to the one or more computers, wherein the one or more storage devices store instructions that, when executed by the one or more computers, cause the one or more computers to perform operations comprising:
receiving a request to convert input text into an audio signal, wherein the input text comprises a plurality of tokenized text inputs;
generating, using a first generative neural network, a semantic representation of the tokenized text inputs comprising semantic tokens representing semantic content of the tokenized text inputs, each semantic token being selected from a vocabulary of semantic tokens;
generating, using a second generative neural network and conditioned on at least the semantic representation, an acoustic representation of the semantic representation comprising one or more respective acoustic tokens representing acoustic properties of the audio signal; and
processing the acoustic representation using a decoder neural network to generate the audio signal.

19. One or more non-transitory computer storage media storing instructions that when executed by one or more computers cause the one or more computers to perform operations comprising:
receiving a request to convert input text into an audio signal, wherein the input text comprises a plurality of tokenized text inputs;
generating, using a first generative neural network, a semantic representation of the tokenized text inputs comprising semantic tokens representing semantic content of the tokenized text inputs, each semantic token being selected from a vocabulary of semantic tokens;
generating, using a second generative neural network and conditioned on at least the semantic representation, an acoustic representation of the semantic representation comprising one or more respective acoustic tokens representing acoustic properties of the audio signal; and
processing the acoustic representation using a decoder neural network to generate the audio signal.

20. The system of claim 18, wherein the first generative neural network has an encoder-decoder Transformer architecture.
